(19) United States
(12) Patent Application Publication
(10) Pub. No.: US 2016/0146448 A1
(43) Pub. Date: May 26, 2016

(54) INTERACTIVE SENSING AND DISPLAYING BUILDING ASSEMBLY

(71) Applicant: MING-HSIAO MA, KAOHSIUNG CITY (TW)

(72) Inventor: MING-HSIAO MA, KAOHSIUNG CITY (TW)

(21) Appl. No.: 14/548,626

(22) Filed: Nov. 20, 2014

(51) Int. Cl. F21V 33/00; F21V 15/01; F21V 23/04

(52) U.S. Cl. CPC F21V 33/006; F21V 23/0464; F21V 15/01

(57) ABSTRACT

An interactive sensing and displaying building assembly includes a base, body pieces and an interactive device. The base includes a frame and bars crossing each other for dividing the interior of the frame into a chamber and rooms communicating with the chamber. The body pieces pervious to light are inserted into the rooms. The interactive device includes a circuit board where sensing portions are arranged. Each sensing portion includes a light sensor directed towards a place which is not shaded by the bars and a plurality of lighting units connected to the light sensor and located under the body pieces. When any light sensor is shaded by an object, a light interruption signal is made to make the corresponding lighting units emit light. The shading action of the object at different time points activates different lighting time of the sensing portions, thereby attaining different lighting and interactive effects.

### BACKGROUND OF THE INVENTION

1. Field of the Invention

This invention relates to a building assembly and relates particularly to an interactive sensing and displaying building assembly.

2. Description of the Related Art

The typical lighting products are not only used for common illumination but used for the landscape lighting design applied to walls, grounds, gardens, etc. For example, the garden design is executed by adopting a light box which includes a body pervious to light and multiple lighting units set inside the body. When the lighting units emit light through the body, there is a different atmosphere in the garden. The landscape design for tall buildings or domiciliary houses is made by forming a recess in which fluorescent lamps are mounted and covering the recess with a cover body which is pervious to light. When the night comes, the fluorescent lamps emit light outwards from walls and grounds of the tall building or from walls and grounds of the domiciliary house. However, the aforementioned light box only appears a static and dull lighting effect and is unable to set different lighting effects according to different environments. Such light box also cannot interact with users. Therefore, this invention is invented.

### SUMMARY OF THE INVENTION

It is an object of this invention to provide an interactive sensing and displaying building assembly which has an interactive device actuated by an outside shading action occurring at different time points, thereby allowing sensing portions of the interactive device to attain different lighting effects at different time points for a special atmosphere and obtain an interactive effect.

Accordingly, the interactive sensing and displaying building assembly in accordance with this invention comprises a base, a plurality of body pieces pervious to light and an interactive device. The base includes a frame and a grid with a plurality of bars crossing each other. The bars divide the interior of the frame into a chamber and a plurality of rooms communicating with the chamber. Each body piece is inserted into each room and positioned by the bars. The interactive device includes a circuit board placed in the chamber and a plurality of sensing portions arranged on the circuit board. Each sensing portion includes a light sensor and a plurality of lighting units connected to the light sensor. The light sensor is directed towards a place which is not shaded by the bars, and each lighting unit is located under each body piece. If any of the light sensors is shaded by an outside object, a light interruption signal is made to make the lighting units in connection with the shaded light sensor emit light. The sensing portions are able to perform different lighting effects when the light sensors are shaded one after another by the outside object, thereby attaining interactive changes for a special atmosphere.

Preferably, the grid includes a plurality of through holes formed on intersections where the bars cross. The through holes communicate with the chamber. Each of the light sensors can be located under each of the intersections and directed towards each of the through holes.

Preferably, a protection unit which is pervious to light is disposed on the base to cover the body pieces. The protection unit can be made of tempered glass, tempered acrylic or other suitable material.

Preferably, the circuit board includes at least one connecting part and at least one matching part respectively disposed on side surfaces of the circuit board. Two or more interactive sensing and displaying assemblies can be connected together by fitting the connecting part and the matching part of one building assembly into the matching part and the connecting part of another adjacent building assembly.

The advantages of this invention are more apparent to those skilled in the art upon reading following descriptions in conjunction with accompanying drawings.

### BRIEF DESCRIPTION OF THE DRAWINGS

FIG. 1 is an exploded view showing a first preferred embodiment of this invention;

FIG. 2 is a cross-sectional view showing the A-A section of FIG. 1;

FIG. 3 is a cross-sectional view showing the first preferred embodiment of this invention in use;

FIG. 4 is an exploded view showing a second preferred embodiment of this invention;

FIG. 5 is a cross-sectional view showing the B-B section of FIG. 4;

FIG. 6 is a cross-sectional view showing the second preferred embodiment of this invention in another variation;

FIG. 7 is a schematic view of this invention applied to a bar table;

FIG. 8 is a schematic view of this invention applied to a passage;

FIGS. 9-11 are cross-sectional views showing a third preferred embodiment of this invention combining with the structure of FIG. 2, FIG. 5 and FIG. 6; and

FIG. 12 is a schematic view showing a fourth embodiment with multiple interactive sensing and displaying assemblies of this invention connected together.

### DETAILED DESCRIPTION OF THE PREFERRED EMBODIMENTS

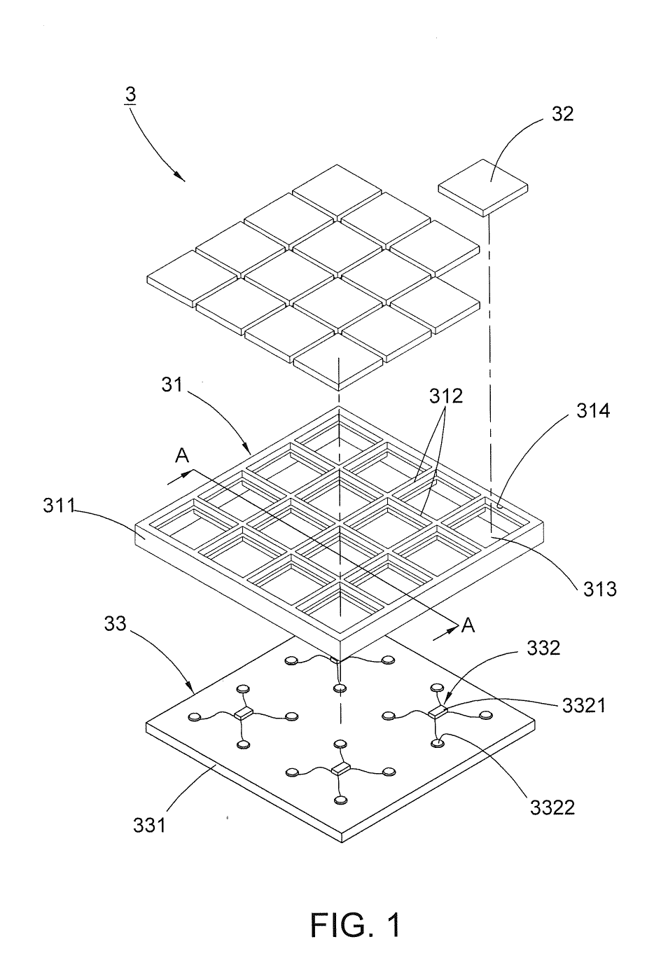

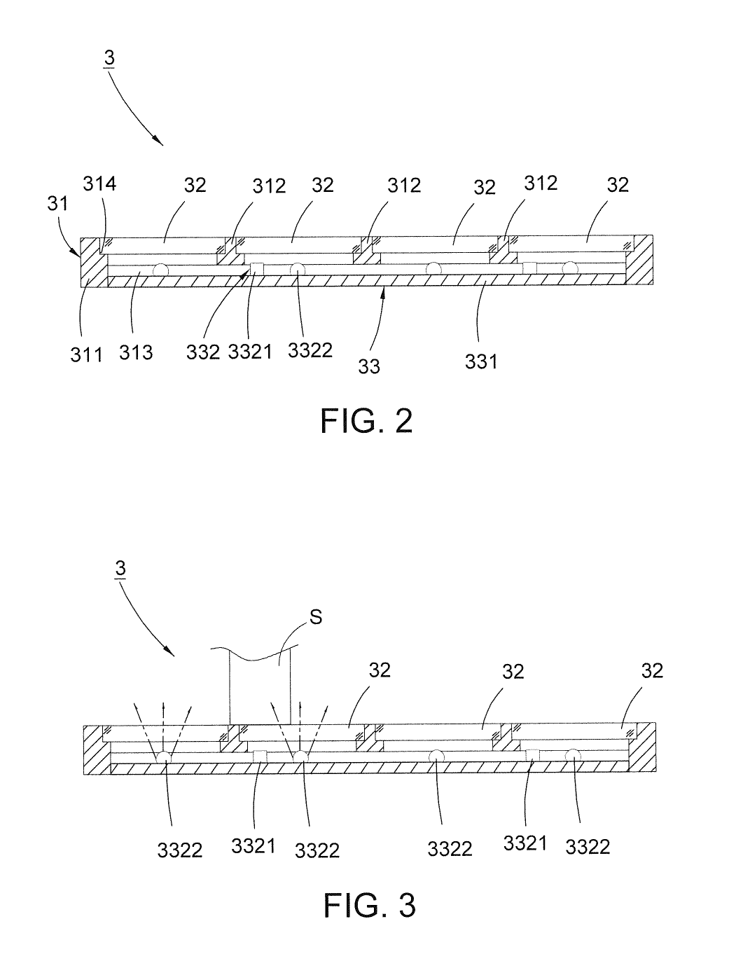

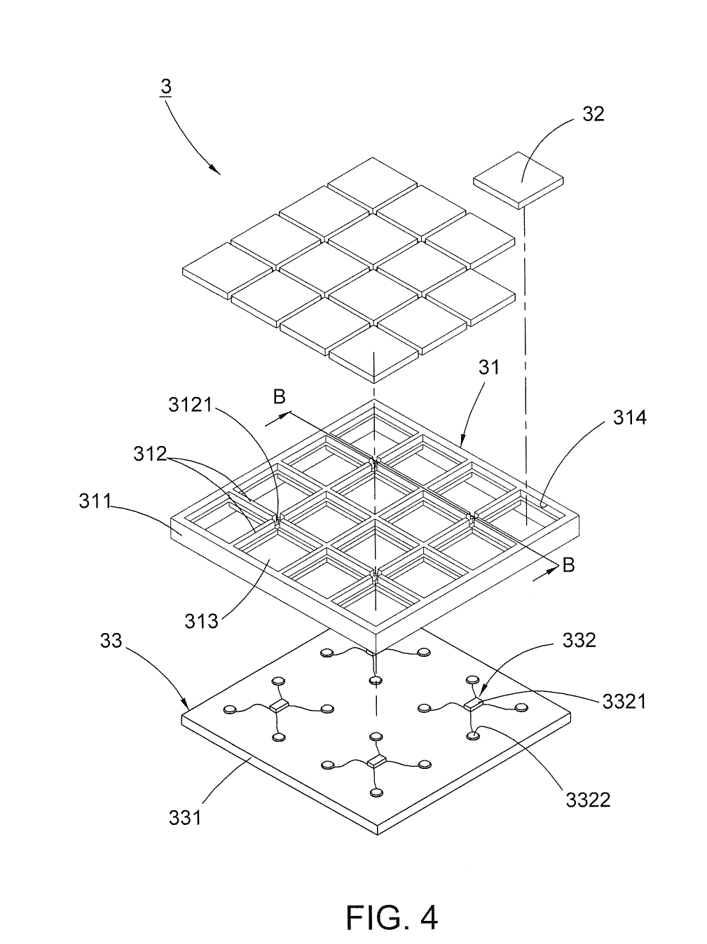

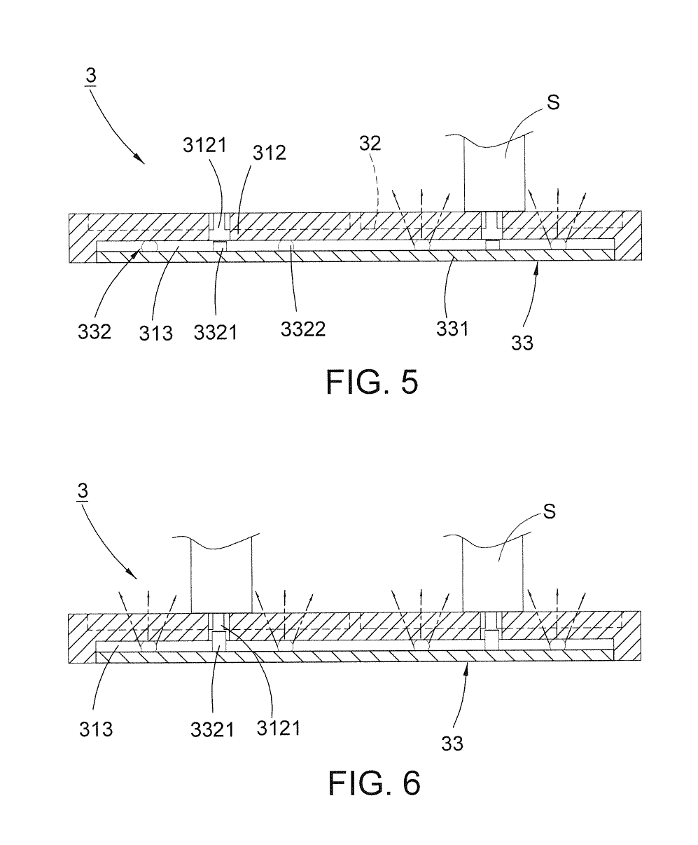

Referring to FIG. 1 and FIG. 2, an interactive sensing and displaying building assembly 3 of a first preferred embodiment of this invention comprises a base 31, a plurality of body pieces 32 and an interactive device 33. The body pieces 32 and the interactive device 33 are placed in the base 31. The base 31 includes a frame 311 and a grid with a plurality of bars 312 crossing each other. The area of the frame 311 and the grid can be extended or adjusted according to the demand, and the shape and the material thereof can be changed to meet the demand. These bars 312 divide an interior of the frame 311 into a chamber 313 and a plurality of rooms 314 communicating with the chamber 313. Each of the body pieces 32 is pervious to light. Each body piece 32 is inserted into each room 314 and positioned by the bars 312. Further, the interactive device 33 includes a circuit board 331 placed in the chamber 313 and a plurality of sensing portions 332 arranged on the circuit board 331. In this preferred embodiment, four spaced-apart sensing portions 332 are shown. The number of the sensing portions 332 may be changed to suit circumstances. Each of the sensing portions 332 includes a light sensor 3321 and a plurality of lighting units 3322 connected to the light sensor 3321. Each of the light sensors 3321 is directed towards a place which is not shaded by the bars 312. For example, FIG. 2 and FIG. 3 show that each light sensor 3321 is placed under each light-pervious body piece 32 directly, thereby detecting directly whether the light sensor 3321 is shaded by any object S. Alternatively, the light sensors 3321, as shown in FIG. 4 and FIG. 5, are respectively placed under intersections where the bars 312 cross, and each intersection defines a through hole 3121 communicating with the chamber 313. Therefore, each light sensor 3321 can be located under each intersection and directed towards each through hole 3121. This prevents the light sensor 3321 from being shaded by the crossed bars 312. Particularly, the light sensor 3321 can be set opposite the through hole 3121 as shown in FIG. 5 or can be inserted into the through hole 3121 as shown in FIG. 6. Therefore, the location of the light sensor 3321 can be adjusted as long as the light sensor 3321 is situated at any place that is not shaded by the bars 312. It is adopted in the following preferred embodiments that the intersections of the bars 312 define through holes 3121 facing the light sensors 3321. Further, each of the lighting units 3322 is located under each of the body pieces 32. The number of the lighting units 3322 may be changed according to the demand. Referring to FIG. 5 or FIG. 6, when any of the light sensors 3321 is shaded by an outside object S to make a light interruption signal, the lighting units 3322 connected to the shaded light sensor 3321 is actuated to emit light. In contrast, when the light sensor 3321 is not shaded by someone or something, the corresponding lighting units 3322 do not emit light.

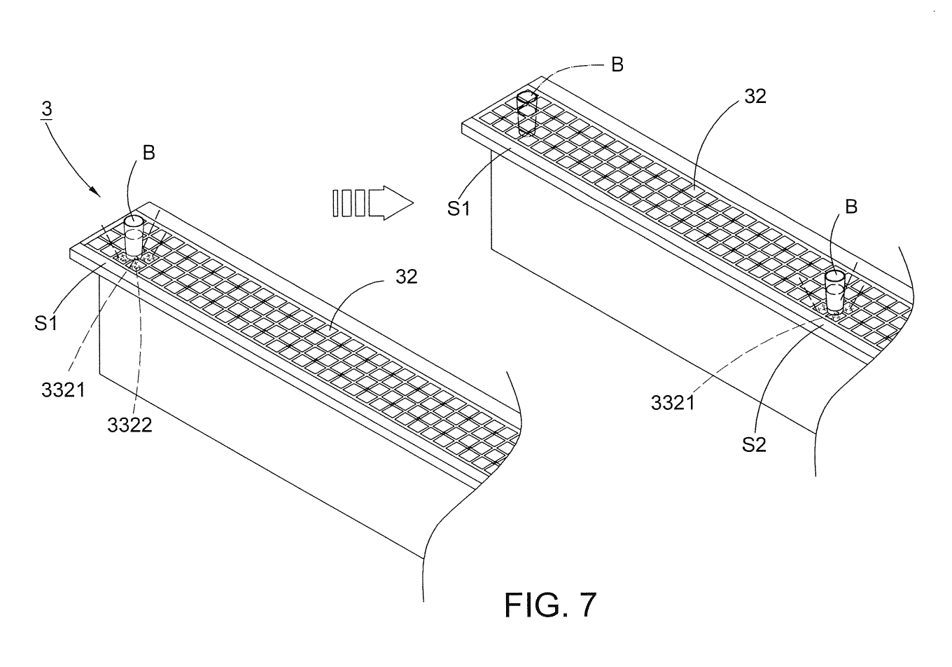

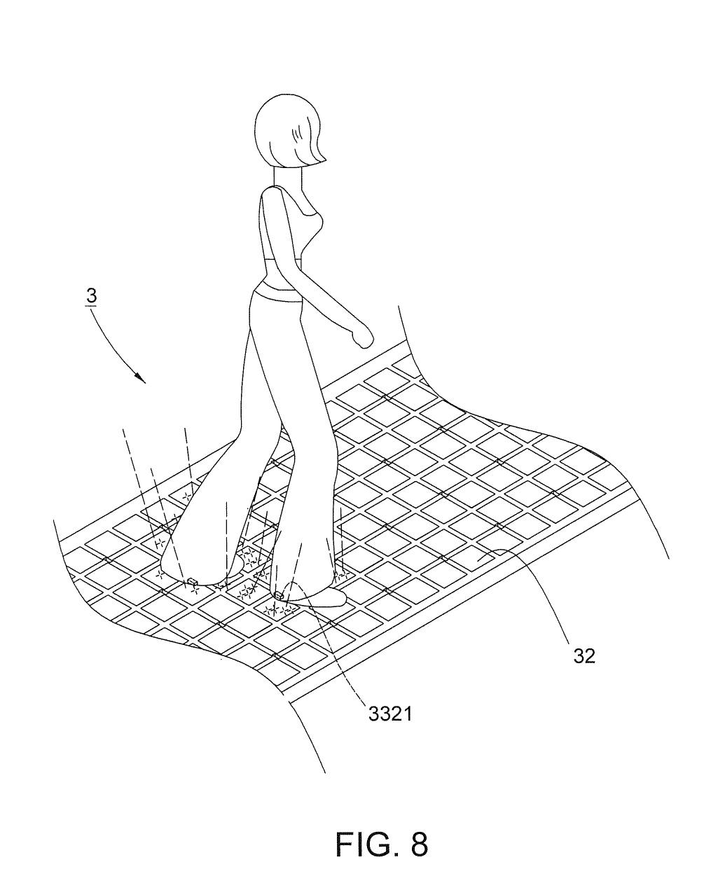

This invention can be adapted to different places, such as the passage of the building, pillars and the home garden, for giving the light to any passerby past the place where the assembly 3 is laid. This invention also allows the sensing portions 332 to interact with the passerby when the sensing portions 332 emit light at different time points owing of shading actions of the passerby at different time points. The applications of this invention are explained with the aid of FIG. 7 and FIG. 8.

Referring to FIG. 4 and FIG. 7, the interactive sensing and displaying building assembly 3 of this invention is applied to a bar table. When a bartender puts a cup of mixed beverage B at a first place S1 of the table in the dark bar, the light sensor 3321 or light sensors 3321 shaded by the beverage B drives the corresponding lighting units 3322 to light. Namely, the lighting units 3322 emit light through the body pieces 32 to make the place where the beverage B is originally situated shine. To serve the beverage B to the customer sitting at a second place S2, the bartender can push the beverage B directly from the place S1 to another place S2. While the beverage B is sliding forwards, places which the beverage B is sliding past are shaded one after another. Therefore, the sensing portions 332 at different places create respective light interruption signals in sequence, and the lighting units 3322 relating to these shaded sensing portions 332 are driven to emit light at different time points. By this lighting performance, the customer can know where the beverage B is placed and where the beverage B is going. After the beverage B reaches the desired place S2, the existence of the beverage B shades the light sensor 3321 or light sensors 3321 at this place to make the corresponding lighting units 3322 emit light whereby the customer drinks the beverage B easily. The lighting variation can also create an amusing atmosphere. Likewise, putting the beverage B at any place where the light sensor 3321 is shaded allows the customer to return the empty cup to the table accurately with the illumination of light. Consequently, this invention attains an auxiliary lighting effect and interacts with users by shading the light sensors 3321 at different time points, thereby increasing the convenience of the use and the amusement.

Referring to FIG. 4 and FIG. 8, the interactive sensing and displaying building assembly 3 of this invention is laid on a passage. When a passerby stands on the passage and defines a standing zone, the light sensor 3321 within the standing zone are shaded by the shadow of the passerby. Therefore, the lighting units 3322 are actuated to emit light through the body pieces 32. Wherever the passerby goes, different sensing portions 332 are shaded and actuated one after another along his or her walking route. Therefore, the sensing portions 332 illuminate at different time points and interact with the passerby. In other words, if a designated place where one or more light sensors 3321 are situated is not shaded by someone or something, the circuit board 331 does not supply the corresponding lighting units 3322 with electricity and the lighting units 3322 do not emit light. The lighting units 3322 are lighting only when the relevant light sensor 332 is shaded by someone or something. In short, whether the lighting units 3322 emit light depends on how and when the user shades the relevant light sensor 3321 or light sensors 3321, thereby attaining an interactive effect. The illumination of the lighting units 3322 is also controlled by the user to provide an auxiliary lighting effect.

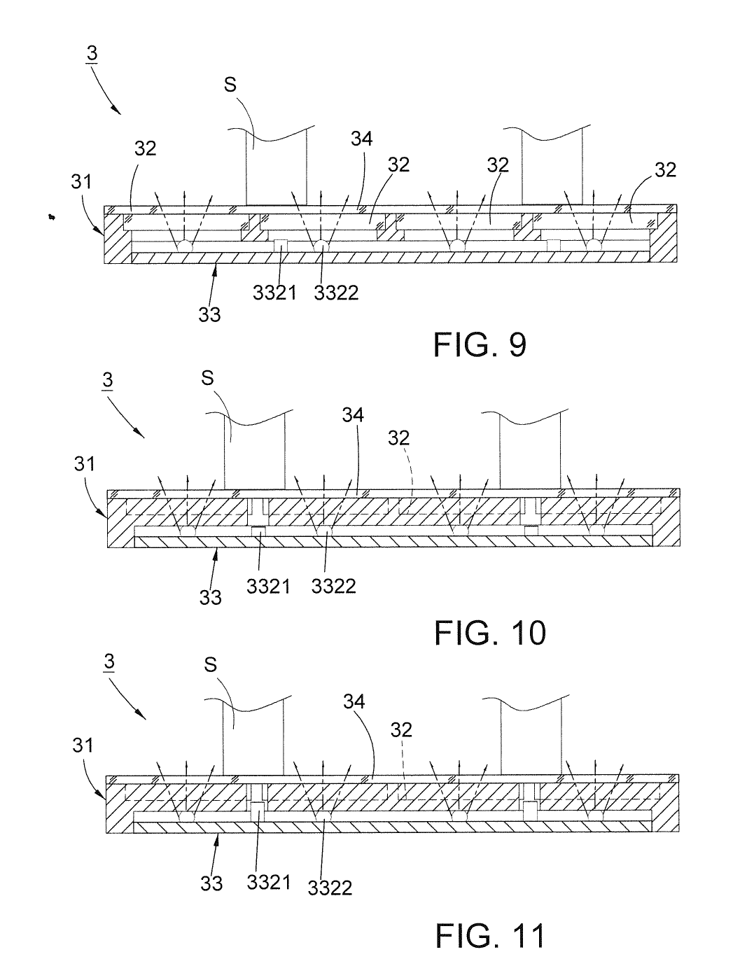

Referring to FIG. 9, a third preferred embodiment of this invention still comprises the same elements, operations and objects as the second preferred embodiment. This preferred embodiment is characterized in that a protection unit 34 is disposed on the top of the base 31 to cover the body pieces 32. This protection unit 34 can be applied to the structure as previously shown in FIG. 2, FIG. 5 and FIG. 6, and the combinations are respectively shown in FIGS. 9-11. This protection unit 34 can be made of tempered glass, tempered acrylic or other suitable material to isolate the body pieces 32 from the outside under the protection of the protection unit 34. The protection unit 34 is also pervious to light so that the lighting units 3322 can emit light through the protection unit 34 when any of the light sensors 3321 is shaded by an object S.

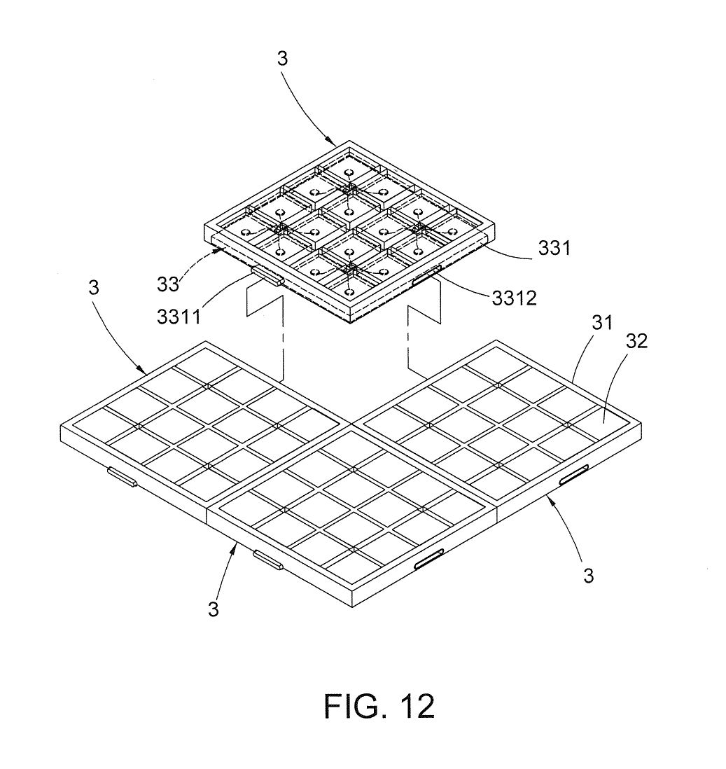

Referring to FIG. 12, a fourth preferred embodiment of this invention still includes a base 31, light-pervious body pieces 32 and an interactive device 33. The concatenation of correlated elements is the same as the second preferred embodiment. Particularly, this embodiment includes a plurality of building assemblies 3 connected together as a group to meet the practical use. To construct the group, each circuit board 331 includes at least one connecting part 3311 and at least one matching part 3312 respectively disposed on side surfaces of the circuit board 331. Therefore, the building assemblies 3 are connected together by fitting the connecting part 3311 and the matching part 3312 of one building assembly 3 into the matching part 3312 and the connecting part 3311 of another adjacent building assembly 3. This allows the building assemblies 3 to be firmly positioned and attains an electrical connection between the circuit boards 331 of the assemblies 3 to render the current loop more stable, prevent the current from inputting and outputting unidirectionally and reduce the damage of the use.

To sum up, this invention takes advantage of the light sensors shaded by the outside object at different time points to make the lighting units connected to the shaded light sensors emit light through the light-pervious body pieces at different time points, thereby revealing a variable lighting effect in contrast with the original environmental light. This invention also takes advantage of the modular base and circuit board to attain changes in the lighting performance, extend an interactive effect and produce a specific atmosphere with the variable illumination effects.

While the embodiments of this invention are shown and described, it is understood that further variations and modifications may be made without departing from the scope of this invention.

1. An interactive sensing and displaying building assembly comprising:
a base including a frame and a grid with a plurality of bars crossing each other, said plurality of bars dividing an interior of said frame into a chamber and a plurality of rooms communicating with said chamber;
a plurality of body pieces, each of which being pervious to light and inserted into each of said rooms and positioned by said bars; and
an interactive device including a circuit board placed in said chamber and a plurality of sensing portions arranged on said circuit board, each of said sensing portions including a light sensor and a plurality of lighting units connected to said light sensor, said light sensor being directed towards a place which is not shaded by said bars, each of said lighting units being located under each of said body pieces, any of said light sensors being shaded by an outside object to drive said lighting units connected to said shaded light sensor to emit light whereby said sensing portions illuminate at different time points when said outside object shades said light sensors at different time points.

2. The interactive sensing and displaying building assembly as claimed in claim 1, wherein said grid includes a plurality of through holes formed on intersections where said bars cross, said through holes communicating with said chamber.

3. The interactive sensing and displaying building assembly as claimed in claim 2, wherein each of said light sensors is located under each of said intersections and directed towards each of said through holes.

4. The interactive sensing and displaying building assembly as claimed in claim 1, wherein a protection unit pervious to light is disposed on said base to cover said body pieces.

5. The interactive sensing and displaying building assembly as claimed in claim 4, wherein said protection unit is made of tempered glass.

6. The interactive sensing and displaying building assembly as claimed in claim 4, wherein said protection unit is made of tempered acrylic.

7. The interactive sensing and displaying building assembly as claimed in claim 1, wherein said circuit board includes at least one connecting part and at least one matching part respectively disposed on side surfaces of said circuit board, thereby allowing a plurality of interactive sensing and displaying assemblies to be connected together by fitting said connecting part and said matching part of one interactive sensing and displaying building assembly into said matching part and said connecting part of another adjacent interactive sensing and displaying building assembly.
